(19) United States
(12) Patent Application Publication
(10) Pub. No.: US 2006/0121997 A1
(43) Pub. Date: Jun. 8, 2006

(54) Christian family entertainment center

(76) Inventor: Yvonne Wimberly-Dyer, Chicago, IL (US)

Correspondence Address: Yvonne Wimberly-Dyer, 7535 So. Perry Ave., Chicago, IL, 60620, US

(21) Appl. No.: 10/913,125

(22) Filed: Dec. 7, 2004

(51) Int. Cl. A63G 31/00; G09B 19/00; A44C 23/00

(52) U.S. Cl. 472/136; 472/137; 434/245; 434/246

(57) ABSTRACT

TUAC INC is a Christian based organization geared toward entertainment for youth Our name Kingdom Zone—It's Not Over is a two phase entertainment center Phase One Kingdom Zone During the day families may purchase tokens to be used for all rides and video games There will be a mini bowling alley, skating rink and a sound proof parent viewing room with computer and internet privileges Guest will be able to purchase a variety of food in addition to our salad bar Our walls will have biblical art work and scenes. The floor staff will be dressed as various biblical persons walking about the center. There will be two/six party rooms Phase Two It's Not Over Guest will be able to lease the private rooms for overnight sleep ins twelve hour maximum There will be several packages to choose from which will include but not limited to biblical themes

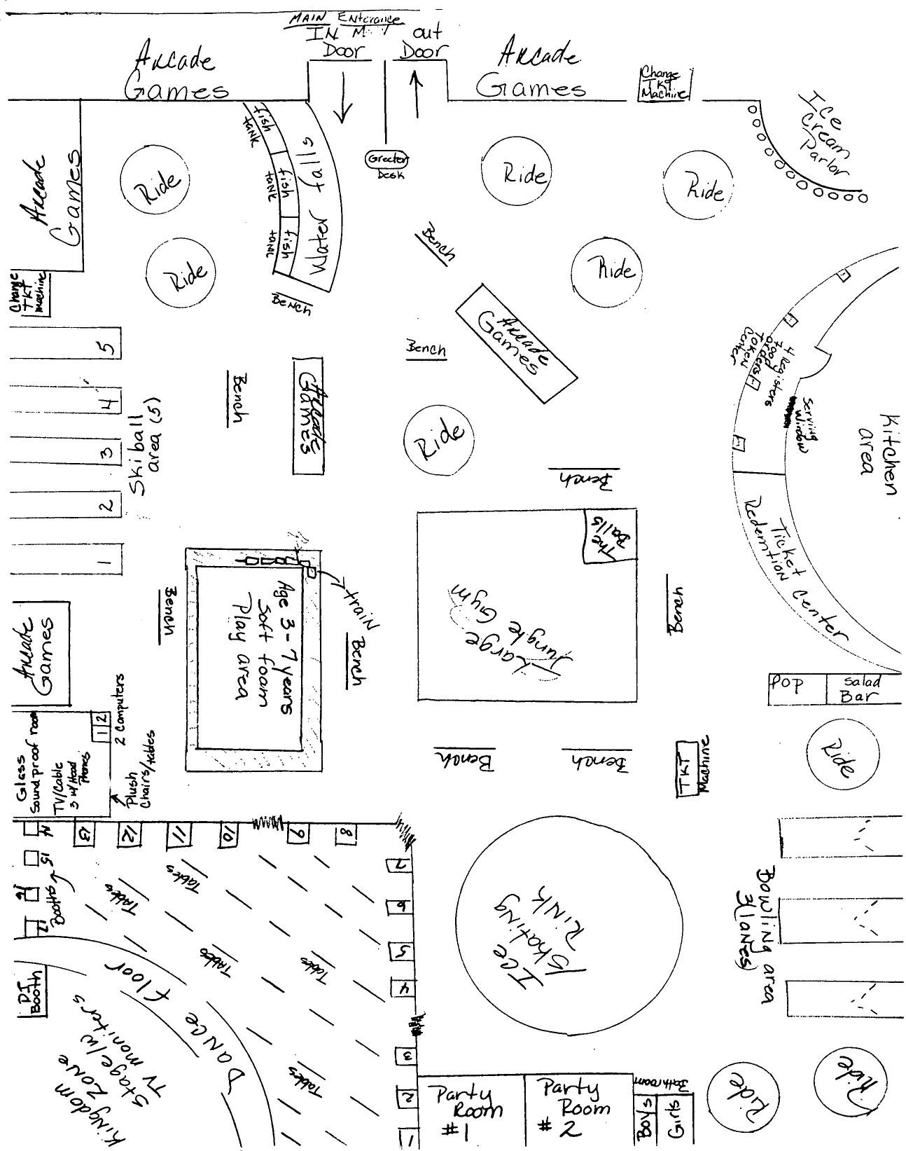

TUAC, INC. dba KINGDOM ZONE—IT'S NOT OVER (an Apostolic approach to Christian Family Entertainment)

purpose to own and operate a Christian Family Entertainment Center. This center will consist of the following:

Christian characters walking throughout the center

Christian animated characters stationed throughout the center

Non violent video games and a number of small and safe family rides

All games and rides will operate by inserting tokens sold in machine throughout the center

A karaoke stage with monitors displaying the words to the songs being song

A food court with a salad bar and an ice cream parlor with a soda fountain

Sound proof parent viewing room and two to Six private party rooms

A mini bowling alley and skating rink

Wall and table Bible Christian trivia questions and or verses

Large TV monitors/screens to view Christian videos and movies

We will be in operation Seven days a week. (daily hours will vary)

Admission policy: Open to all ages, however, all children under 16 years of age MUST be accompanied by an adult.

1. A Christian family entertainment center
the christian family entertainment center will have a main room entry
said main room will have several activities to include, a stage, dance floor, children and adult rides and video games operated by tokens, seating booths, seating benches, chairs and tables, ice skating rink, ice cream parlor, a water fall, fish tanks, bathrooms, sound proof computer room, snack bar, mini bowling alley, infant and toddler play room
said main entry room will branch into smaller private rooms
the rooms will be used for private guest parties and functions
the christian family entertainment center will have uniformed employees
said employees uniforms will be based on the attire worn during 1 ad to 40 ad
whereby, said family entertainment center will be spiritually based to enhance the limited Christian activities available to the Christian family and community.

2. An christian entertainment center
(a) the entertainment center will have several employees
(b) said employees costume-uniforms will be that of early biblical times
(c) the entertainment center will have token operated rides and video games
(d) said entertainment center will have a water fall with attached fish tanks
(e) the entertainment center will have a sound proof computer room
(f) said computer room will serve as an observation and work room for parents
(g) a snack bar and ice cream parlor will be located near a token redeeming station
(h) seating booths and tables with chairs will surround a stage and dance floor
(i) backless benches will be stationed throughout the main floor area
(j) there will be a mini bowling alley and ice skating rink
(k) the entertainment center main room will branch into several private rooms
(l) said rooms will be used for private guest parties and a infant and toddler play room
whereby, said Christian entertainment center will be a place for Christian families to enjoy spiritual fun and amusement.
